(19) United States
(12) Patent Application Publication
(10) Pub. No.: US 2021/0075897 A1
(43) Pub. Date: Mar. 11, 2021

(54) TRIPLE CAMERA DEVICE AND TERMINAL DEVICE

(71) Applicant: Huawei Technologies Co., Ltd., Shenzhen (CN)

(72) Inventors: Xin LI, Shenzhen (CN); Deliang LI, Shanghai (CN)

(21) Appl. No.: 16/982,413

(22) PCT Filed: Mar. 27, 2019
(86) PCT No.: PCT/CN2019/079828

§ 371 Date: Sep. 18, 2020

(30) Foreign Application Priority Data
Mar. 27, 2018 (CN) 201810260639.1

(51) Int. Cl. H04M 1/02; H04N 5/225

(52) U.S. Cl. CPC H04M 1/0264; H04N 5/2253; H04M 2250/52; H04N 5/2258; H04N 5/2257

(57) ABSTRACT

This application provides a triple camera device and a terminal device. The triple camera device includes a first camera, a second camera, and a third camera. A third motor in the third camera is disposed between a first motor in the first camera and a second motor in the second camera, to avoid magnetic interference between the first motor and the second motor. In addition, a distance between two magnets that are closest to each other and that are respectively in N second magnets in the second motor and third magnets in the third motor is greater than or equal to a first preset threshold. This reduces magnetic interference between the second motor and the third motor.

### CROSS-REFERENCE TO RELATED APPLICATIONS

This application is a National Stage of International Patent Application No. PCT/Cn2019/079828, filed Mar. 27, 2019, which claims priority to Chinese Patent Application No. 201810260639.1, filed Mar. 27, 2018. The disclosures of the aforementioned applications are hereby incorporated by reference in their entireties.

### TECHNICAL FIELD

This application relates to the field of terminal devices, and more specifically, to a triple camera device and a terminal device.

### BACKGROUND

A camera in a mobile phone includes a motor. The motor usually has at least one of an auto focus (AF) function and an image stabilization function. The auto focus is implemented by using an AF coil and two magnets. The image stabilization function is mainly implemented by using four magnets and four coils that can suspend and support the four magnets in a power-on state.

Currently, a mobile phone mainly includes two cameras (namely, dual cameras), and interference is generated between two motors in the dual cameras. In a conventional solution, magnetic interference between the motors is mainly avoided by using software, but this may cause deterioration of photographing experience (for example, focusing time).

A triple camera device is a development trend of cameras, and how to reduce magnetic interference between motors in the triple camera device needs to be urgently resolved.

### SUMMARY

This application provides a triple camera device and a terminal device. The triple camera device can reduce magnetic interference between motors.

According to a first aspect, a triple camera device is provided. The triple camera device includes: a first camera, where the first camera includes a first motor, the first motor includes a first auto focus AF coil and M first magnets, and the M first magnets are placed pairwise opposite to each other along an outer wall of the AF coil, where M is a positive integer, and M is a multiple of 2;

a second camera, where the second camera includes a second motor, the second motor includes N second OIS coils and N second magnets, the second OIS coil is configured to suspend and support the second magnet when powered on, planes used by the N second magnets to support a lens are a same plane, and the N second magnets are placed pairwise opposite to each other around an inner wall of the second motor, where N is a positive integer, and N is a multiple of 4; and a third camera, where the third camera includes a third motor, the third motor is disposed between the first motor and the second motor, the third motor includes a third AF coil and K third magnets, and the K third magnets are placed pairwise opposite to each other along an outer wall of the third AF coil, where K is a positive integer, K is a multiple of 2, and a shortest distance of distances between the K third magnets and the N second magnets is greater than or equal to a first preset distance.

The triple camera device includes the first camera, the second camera, and the third camera. The third motor in the third camera is disposed between the first motor in the first camera and the second motor in the second camera, to avoid magnetic interference between the first motor and the second motor. In addition, the distance between two magnets that are closest to each other and that are respectively in the N second magnets in the second motor and the K third magnets in the third motor is greater than or equal to the first preset threshold, to reduce magnetic interference between the second motor and the third motor.

In some possible implementations, a shortest distance of distances between the M first magnets and the K third magnets is greater than or equal to a second preset distance.

The distance between two magnets that are closest to each other and that are respectively in the first motor and the second motor is set, so that the magnetic interference between the first motor and the second motor is reduced, and user experience is improved.

In some possible implementations, the second motor further includes at least one second Hall sensor, and the second Hall sensor is disposed between the second magnet and the second OIS coil corresponding to the second magnet, and a shortest distance of distances between the second Hall sensor and the third magnets is greater than or equal to a third preset distance.

The second motor may be a closed-loop motor with an image stabilization function. When precision of image stabilization performance is improved, interference between the second Hall sensor in the second motor and the magnets in the third motor is reduced.

In some possible implementations, the third motor further includes at least one third Hall sensor, and a shortest distance of distances between the at least one third Hall sensor and the N second magnets is greater than or equal to a fourth preset distance.

The distances between the Hall sensor in the third motor and the magnets in the second motor are set, so that interference between the Hall sensor in the third motor and the magnets in the second motor is reduced.

In some possible implementations, the third motor further includes at least one third Hall sensor, and a shortest distance of distances between the at least one third Hall sensor and the M first magnets is greater than or equal to a fifth preset distance.

The distances between the Hall sensor in the third motor and the magnets in the first motor are set, so that interference between the Hall sensor in the third motor and the magnets in the first motor is reduced.

In some possible implementations, the first motor further includes at least one first Hall sensor, and a shortest distance of distances between the at least one first Hall sensor and the K third magnets is greater than or equal to a sixth preset distance.

The distances between the first Hall sensor in the first motor and the third magnets in the third motor are set, so that interference between the Hall sensor in the first motor and the third magnets in the third motor is reduced.

In some possible implementations, a cross section that is of the second motor and that is parallel to a lens surface is rectangular, and the N second magnets are disposed around a frame parallel to the second motor, or the N second magnets are disposed in four corners of the second motor.

The magnets in the second motor may be disposed in the four corners, to reduce relatively small space occupied by the second magnets inside the second motor, and further reduce a volume of the second motor.

In some possible implementations, a cross section that is of the first motor and that is parallel to a lens surface is rectangular, and the M first magnets are disposed on least two sides of a frame parallel to the first motor, or the M first magnets are disposed in at least two of four corners of the first motor.

The magnets in the first motor may be disposed in the four corners, to reduce relatively small space occupied by the second magnets inside the second motor, and further reduce a volume of the second motor.

In some possible implementations, a cross section that is of the third motor and that is parallel to a lens surface is rectangular, and the K first magnets are disposed on at least two sides of a frame parallel to the third motor, or the K third magnets are disposed in at least two of four corners of the third motor.

The magnets in the first motor may be disposed in the four corners, to reduce relatively small space occupied by the second magnets in the second motor, and further reduce a volume of the second motor.

In some possible implementations, a length of a cross section that is of the third magnet and that is parallel to a lens surface is less than or equal to a seventh preset distance.

In the third motor, the length of the cross section that is of the third magnet and that is parallel to the lens surface may be reduced without affecting performance of the third magnet in the third motor. This reduces interference of the third magnet to the first motor and the second motor.

In some possible implementations, the second motor further includes a second AF coil, and the N second magnets are placed around an outer wall of the second AF coil.

The second motor not only has an image stabilization function, but also may have an auto focus function. In other words, the second motor may be an OIS motor.

In some possible implementations, when a value of K is 2, the two third magnets are disposed on two sides of the third motor that are parallel to a central axis of the triple camera device, and the central axis may be a straight line in which a center of the first camera, a center of the second camera, and a center of the third camera are located.

Center axes of the first camera, the second camera, and the third camera in the triple camera device may be in a same straight line, and the third magnets may be disposed at locations parallel to the center axes. In this way, interference between the third magnets and the magnets in the second motor is reduced by setting a location structure. In some possible implementations, the third magnets are disposed in the middle of sides of the frame of the third motor.

Optionally, the third magnets are disposed in the middle of sides of the frame of the third motor.

A third magnet is located in the middle of a lower side of the frame of the third motor. In this case, it is easier to dispose the magnet in the third motor, and reliability is relatively high.

According to a second aspect, a terminal device is provided. The terminal device includes the triple camera device according to the foregoing first aspect or any possible implementation.

Based on the foregoing technical solution, the triple camera device includes the first camera, the second camera, and the third camera. The third motor in the third camera is disposed between the first motor in the first camera and the second motor in the second camera, to avoid magnetic interference between the first motor and the second motor. In addition, the distance between two magnets that are closest to each other and that are respectively in the N second magnets in the second motor and the K third magnets in the third motor is greater than or equal to the first preset threshold. This reduces magnetic interference between the second motor and the third motor.

### BRIEF DESCRIPTION OF DRAWINGS

FIG. 1 is a schematic diagram of an internal structure of a closed-loop AF motor;

FIG. 2 is a schematic diagram of a focusing process;

FIG. 3 is a schematic diagram of stress analysis of auto focus work;

FIG. 4 is a side view of a motor with an optical image stabilization (OIS) function;

FIG. 5 is a structural diagram of an OIS motor;

FIG. 6 is a flowchart of an open loop and a closed loop;

FIG. 7 is a schematic diagram of a triple camera device according to an embodiment of this application;

FIG. 8 is a schematic diagram of a triple camera device according to another embodiment of this application;

FIG. 9 is a schematic diagram of a triple camera device according to still another embodiment of this application;

FIG. 10 is a schematic diagram of a triple camera device according to yet another embodiment of this application;

FIG. 11 is a schematic diagram of a triple camera device according to still yet another embodiment of this application;

FIG. 12 is a schematic diagram of a triple camera device according to a further embodiment of this application; and

FIG. 13 is a schematic diagram of a bipolar magnet.

### DESCRIPTION OF EMBODIMENTS

The following describes technical solutions of this application with reference to the accompanying drawings.

For ease of understanding embodiments of this application, the following elements are first described before the embodiments of this application are described.

An AF motor has an auto focus function. The AF motor mainly includes an AF coil and at least two magnets pairwise opposite to each other. In a permanent magnetic field formed by the at least two magnets, the AF coil is powered on to control movement of a lens, and the AF motor mainly adjusts a focal length by moving in a vertical direction. The AF motor may also be referred to as an open-loop AF motor.

In addition, the AF motor may further include a Hall sensor. The Hall sensor measures magnetic field strength to determine a lens location more precisely. Therefore, the AF motor can move a location of the entire lens by a micro distance, and control a length of the focal length, to obtain a clear image. The AF motor may be referred to as a closed-loop AF motor.

It should be understood that the AF motor in the embodiments of this application may be a voice coil motor, a stepper motor, liquid lens focusing, a memory alloy motor, or a focus motor of a liquid crystal lens.

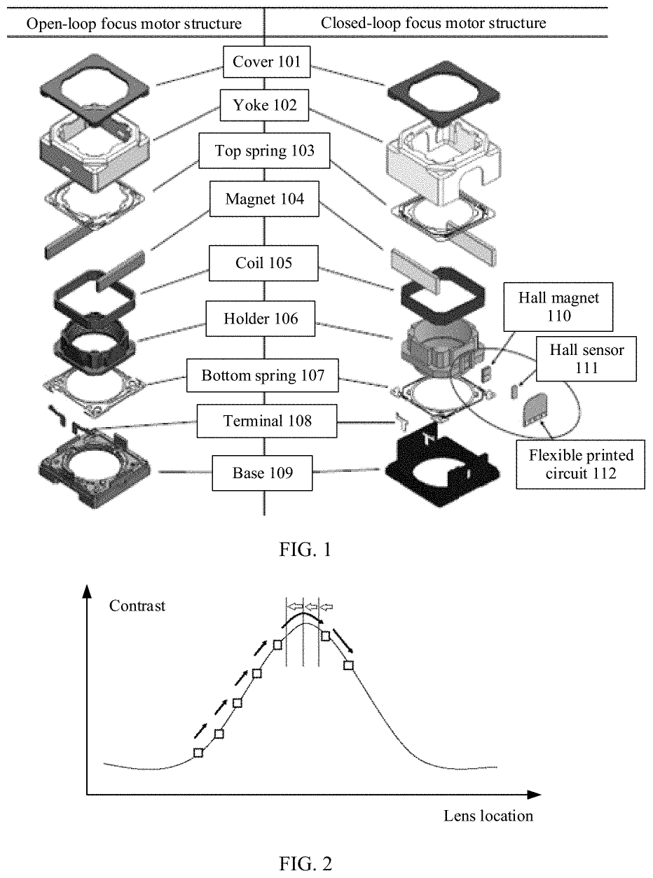

Specifically, FIG. 1 shows an internal structure of a closed-loop AF motor. The closed-loop AF motor includes a cover 101 (COVER), a yoke 102 (YOKE), a top spring 103 (SPRING-TOP), a magnet 104 (MAGNET), a coil 105 (COIL), a holder 106 (HOLDER), a bottom spring 107 (SPRING-BTM), a terminal 108 (TERMINAL), a base 109 (BASE), a Hall magnet 110 (MAGNET HALL ELEMENT), a Hall sensor 111 (HALL ELEMENT), and a flexible printed circuit 112 (FPC). A difference between an open-loop AF motor and the closed-loop AF motor lies in that there is no Hall sensor 111 on the bottom spring.

FIG. 2 shows a focusing process. The focusing process includes: moving a lens to find two clearest areas, and then slightly moving the lens in the two areas to find a clear focusing point. A specific focusing process includes the following steps.

(1) In a non-focus state, a defocus image presented on a preview screen is in a defocus state.

(2) Start to focus, and start to move the lens, so that the image is gradually clear, and contrast is increased.

(3) In a focus state, the image is the clearest and the contrast is the highest. However, a terminal continues to move the lens.

(4) Continue to move the lens to find that the contrast starts to decrease. Further move the lens to find that the contrast further decreases, which indicates that the focusing point is missed.

(5) Move back the lens to a location with the highest contrast, to complete focus.

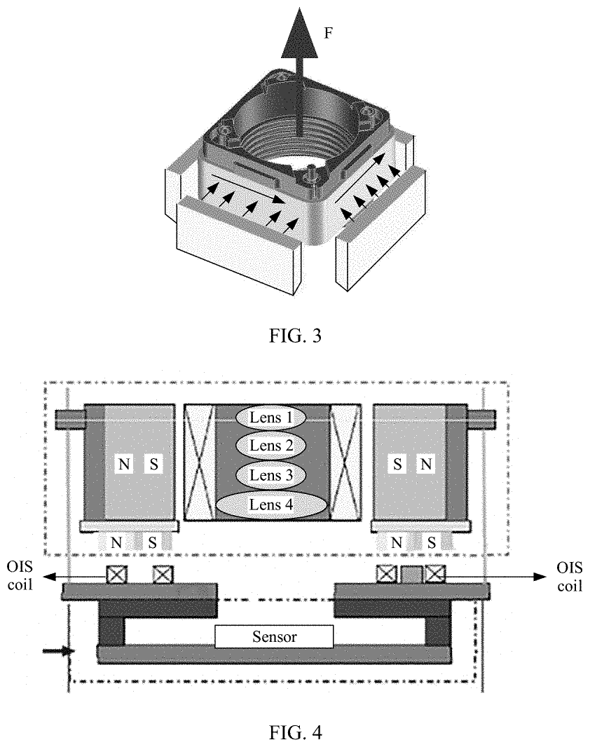

Specifically, an operating principle of auto focus is that in a permanent magnetic field, a stretch location of a spring plate is controlled by changing a value of a direct current of an AF coil, to drive the lens to move up and down. For example, FIG. 3 shows a stress condition of auto focus work: F=IL*B sin α, Fi=fs+gL, where F is ampere force, fs is spring elastic force, and gL is lens gravity.

An OIS motor has an auto focus function and an image stabilization function. An implementation of the auto focus function is the same as an implementation of the auto focus function of the AF motor. FIG. 4 is a side view of a motor with an OIS function. A plane on which a lens is located is a plane facing inward and perpendicular to a paper surface. As shown in FIG. 4, the OIS function of the motor is implemented by a lens suspender including four magnets pairwise opposite to each other and four OIS coils (as shown in FIG. 4). The OIS motor may be referred to as an open-loop OIS motor.

In addition, the OIS motor may also include a Hall sensor, and the OIS motor is referred to as a closed-loop OIS motor.

The OIS motor mainly includes a translation OIS focus motor and an axis-moving focus motor. Principles of these two types of OIS motors are the same, and each are configured to control a lens to translate relative to an image sensor, so as to eliminate and compensate for an image offset caused by hand shaking. A type of the OIS motor is not limited in the embodiments of this application.

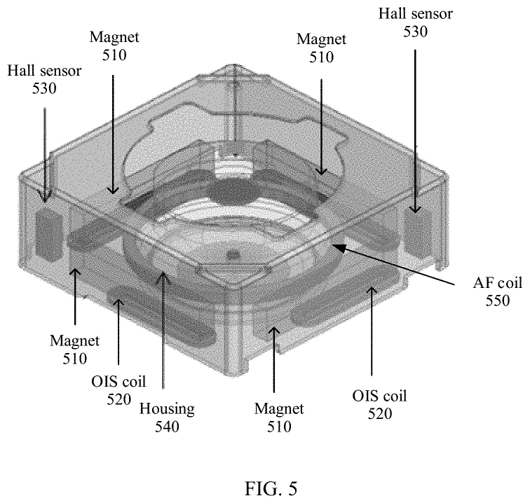

FIG. 5 is a structural diagram of an OIS motor. As shown in FIG. 5, the OIS motor usually includes four magnets 510, four OIS coils 520, and a Hall sensor in an (X-Y)-axis direction and/or a Hall sensor 530 in a Z-axis direction, a housing 540, and an AF coil 550. The housing is usually made of an aluminum material. The four magnets are fixed on a yoke along a periphery. After the OIS coils are powered on, the magnets and the OIS coils generate magnetic force, to drive a carrier of the lens to move. The Hall sensor in the (X-Y)-axis direction is configured to detect a magnetic field change in the X and Y directions, and the Hall sensor in the Z-axis direction is configured to detect a magnetic field change in the Z-axis direction. In other words, the OIS motor can not only move the lens in a vertical direction, but also move the lens in a horizontal direction. It should be noted that the Hall sensor in FIG. 5 is a Hall sensor 530 in the Z-axis direction.

FIG. 6 is a flowchart of an open loop and a closed loop. The open loop has a simple structure and low costs, works stably, and has a relatively good control effect when an input signal and disturbance can be known in advance. However, an offset of a controlled variable cannot be automatically corrected, and an element parameter change in a system and external unknown disturbance affect control precision.

The closed loop has a capability of automatically correcting the offset of the controlled variable by using feedback control, can correct an error caused by the element parameter change and external disturbance, and has high control precision. A closed-loop AF motor or a closed-loop OIS motor mainly implements the foregoing function by using a Hall sensor. The Hall sensor may measure a gauss value in a magnetic field, to further determine a location of a lens through the measurement. Specifically, the Hall sensor is used to sense magnetic field strength at a 0 location and a max location of the lens, and the magnetic field strength is stored in a driver. In movement of a focus lens group, magnetic field strength at a moving location can be continuously measured, and the intensity is returned to the driver. The driver obtains a positive/negative error based on a returned value, and then controls a movement direction and a speed of the focus lens group based on the positive/negative error, so that the focus may be implemented more accurately and fast.

For example, a gyroscope disposed inside a terminal device converts shaking information into an electrical signal, and sends the electrical signal to an OIS control driver. The OIS control driver drives the motor to control movement of a suspended lens, to compensate for an effect caused by shaking. The Hall sensor feeds back location information of the lens to the OIS control driver, to form complete closed-loop control.

A triple camera device is a development trend of cameras, and how to reduce magnetic interference between motors in the triple camera device needs to be urgently resolved.

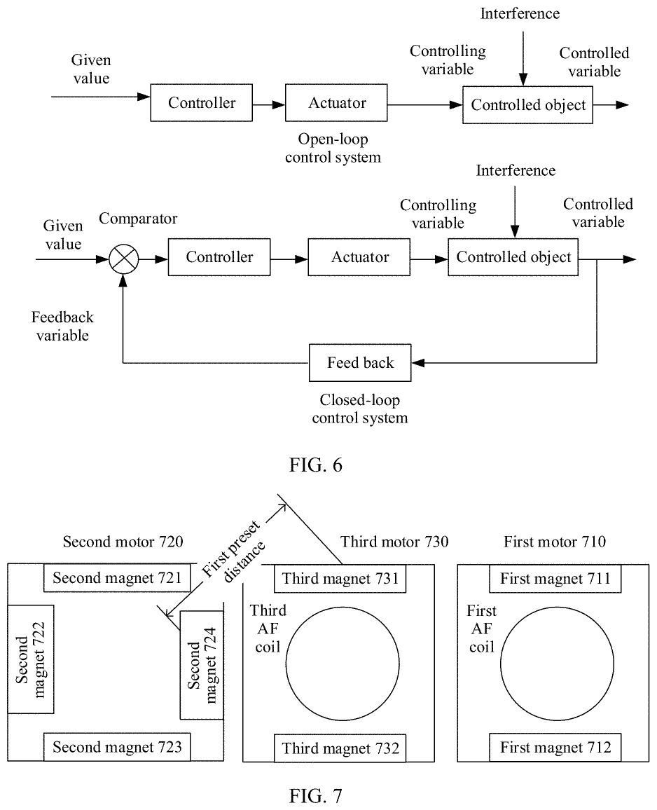

FIG. 7 is a schematic diagram of a triple camera device according to an embodiment of this application.

As shown in FIG. 7, the triple camera device includes three cameras. In this application, an example in which the three cameras are respectively a first camera, a second camera, and a third camera is used for description. In addition, a sectional view parallel to a plane on which a camera mirror surface is located is used for description in the following embodiments.

The first camera includes a first motor 710. The first motor 710 includes a first AF coil and M first magnets. The M first magnets are placed pairwise opposite to each other along an outer wall of the first AF coil, where M is a positive integer, and M is a multiple of 2.

The second camera includes a second motor 720. The second motor 720 includes N second OIS coils and N second magnets. The second OIS coils are configured to suspend and support the second magnets when powered on. Planes used by the N second magnets to support the lens are a same plane, and the N second magnets are placed pairwise opposite to each other around an inner wall of the second motor, where N is a positive integer, and N is a multiple of 4.

The third camera includes a third motor 730. The third motor 730 is disposed between the first motor and the second motor. The third motor includes a third AF coil and K third magnets. The K third magnets are placed pairwise opposite to each other along an outer wall of the third AF coil, where K is a positive integer, and K is a multiple of 2. In addition, a shortest distance of distances between the K third magnets and the N second magnets is greater than or equal to a first preset distance.

Specifically, as shown in FIG. 7, the M first magnets in the first motor 710 are disposed pairwise opposite to each other on the outer wall of the first AF coil, and the K third magnets in the third motor 730 are disposed pairwise opposite to each other on the outer wall of the third AF coil, where M is a multiple of 2, and K is a multiple of 2. For ease of description, the following embodiments are described by using an example in which the first motor includes two first magnets (a first magnet 711 and a first magnet 712), and the third motor includes two third magnets (a third magnet 731 and a third magnet 732).

Surfaces that are of the N second magnets in the second motor 720 and that are used to support movement of the lens may be on a same plane, or centers of the second magnets are also on a same plane. The N second magnets can be used together to control the movement of the lens. The second OIS coils can suspend and support the second magnets when powered on (In the embodiments of this application, a direction facing inward and perpendicular to a paper surface is used to indicate downward. In this case, the OIS coils are under the magnets, and this is not shown in FIG. 7). For example, the second motor in FIG. 7 includes four second magnets: a second magnet 721, a second magnet 722, a second magnet 723, and a second magnet 724. In other words, one second OIS coil is disposed under each second magnet. Specifically, a location relationship between the second magnets and the second OIS coils may be shown in FIG. 5.

The third motor is disposed between the first motor and the second motor, to reduce magnetic interference between the first motor and the second motor. In addition, that the shortest distance of the distances between the K third magnets and the N second magnets is greater than or equal to the first preset distance may be that a distance between two magnets that are closest to each other and that are respectively in the N second magnets in the second motor and the K third magnets in the third motor is greater than or equal to the first preset threshold, to reduce magnetic interference between the second motor and the third motor.

In the embodiments of this application, the first motor and the third motor may be open-loop AF motors, and the second motor may be an open-loop motor with an image stabilization function.

It should be noted that a distance between two magnets may be a distance between centers of the two magnets, or may be a largest distance between an outermost edge of one of the magnets and an outermost edge of the other magnet, or may be a shortest distance between an innermost edge of one magnet and an innermost edge of the other magnet, or may be a distance between an outermost edge of one magnet and an innermost edge of the other magnet. In the following embodiments, a distance between two modules is described by using a distance between centers of the two modules as an example. This is not limited in this application.

It should be understood that the first preset distance may further be determined based on factors such as internal space sizes of the two motors (that is, the first preset distance is less than or equal to a largest distance between internal components of the two motors), and measurement data, and may be configured at delivery or configured by a user based on a requirement. This is not limited in this application.

It should be further understood that the first magnets may alternatively be disposed on an inner wall of the first motor, and there may be a gap between the first AF coil and the first magnets, or the first AF coil may be in contact with the first magnets. This is not limited in this application. The third magnets may alternatively be disposed on an inner wall of the third motor, and there may be a gap between the third AF coil and the third magnets, or the third AF coil may be in contact with the third magnets. This is not limited in this application. For example, a gap between the two motors may be configured based on an actual application, and is usually set to be less than 1.5 mm, for example, 1 mm or 0.8 mm.

It should be further understood that all or some of the second OIS coils may face the second magnets. This is not limited in this application.

It should be further understood that a location sequence of the first camera and the second camera is not limited in the embodiments of this application.

Optionally, the second motor may further include a second AF coil, and the N second magnets are placed around an outer wall of the second AF coil. In other words, the second motor is an OIS motor.

Optionally, the first AF coil, the second AF coil, or the third AF coil in the embodiments of this application may be in a ring shape, may be in a rectangle shape, or may be in a rectangle shape with four corners being rounded corners. This is not limited in this application.

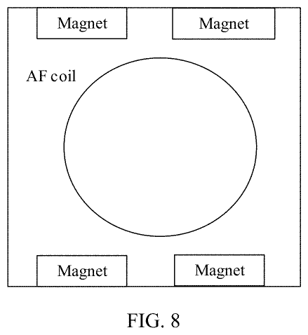

Optionally, a specific value of M may be determined based on an internal size of the motor, a spacing between the motor and an adjacent motor, and the like. This is not limited in this application. For example, if M is 4, a layout of the first magnets in the first motor may be shown in FIG. 8, or the first magnets are placed around the first motor. This is not limited in this application.

Optionally, when M is 4, an OIS coil may be disposed under the magnets for the first motor. In other words, the first motor is an OIS motor.

Optionally, a specific value of K may be determined based on an internal size of the motor, a spacing between the motor and an adjacent motor, and the like. This is not limited in this application. For example, if K is 4, a layout of the third magnets in the third motor may also be shown in FIG. 8, or the third magnets are placed around the third motor. This is not limited in this application.

Optionally, when K is 4, an OIS coil may be disposed under the magnets for the third motor. In other words, the third motor is an OIS motor.

Optionally, a distance between two magnets that are closest to each other and that are respectively in the M first magnets and the K third magnets is greater than or equal to a second preset distance.

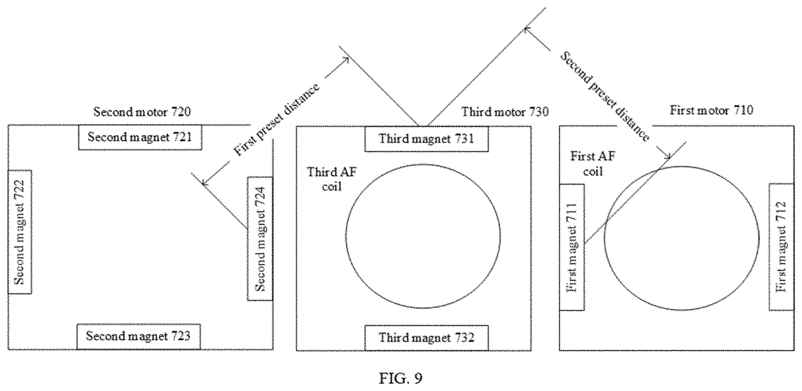

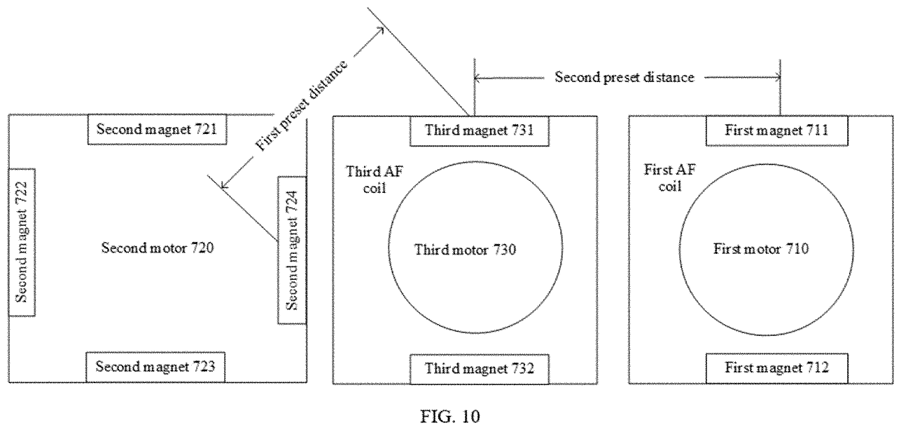

Specifically, locations of the first magnets in the first motor may be shown in FIG. 9, or may be shown in FIG. 10. This is not limited in this application.

Optionally, the second motor may further include at least one second Hall sensor, and the at least one second Hall sensor may be disposed between the second magnet and the second OIS coil.

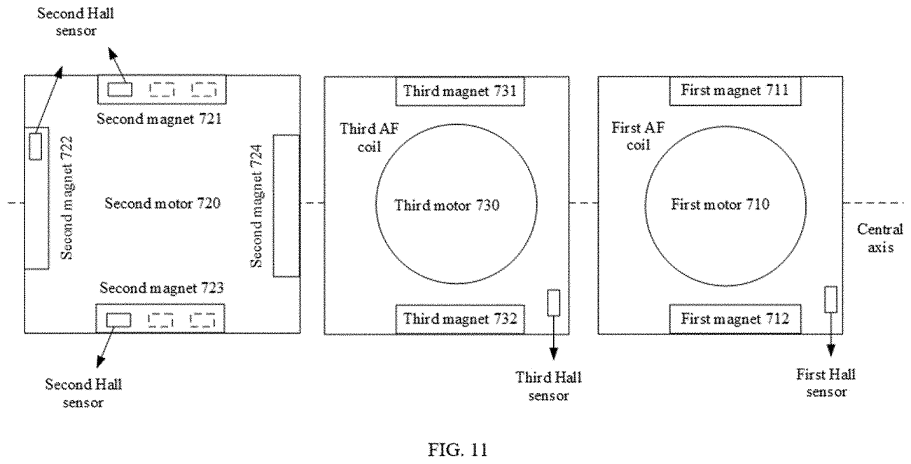

Specifically, the second motor may alternatively be a closed-loop motor with an image stabilization function. To be specific, the second motor may further include at least one second Hall sensor, and the at least one second Hall sensor may be disposed between any second magnet and the second OIS coil in the second motor, for example, as shown in FIG. 11.

It should be understood that magnetic interference between a Hall sensor and a magnet in a same motor may be calibrated in a production line calibration process because a module of the motor is a fixed value.

It should be noted that the Hall sensor in the embodiments of this application may be disposed in an (X-Y)-axis direction, or may be disposed in a Z-axis direction. This is not limited in this application.

Optionally, a shortest distance of distances between the second Hall sensor and the third magnets is greater than or equal to a third preset distance.

Specifically, because magnetic interference may be generated between the Hall sensor and a magnet in an adjacent motor, the shortest distance of the distances between the second Hall sensors and the third magnets in the third motor may be greater than or equal to the third preset distance. In this way, magnetic interference between the second motor and the third motor is further reduced.

For example, if the second Hall sensor is disposed under the second magnet 721, and there are three locations for disposing the second Hall sensor under the second magnet 721, the second Hall sensor may be disposed at a location at which distances between the second Hall sensor and the third magnets 731 are greater than or equal to the third preset distance, or the second Hall sensor is disposed at a leftmost location of the second magnet 721 or the second magnet 723.

Optionally, the third motor further includes at least one third Hall sensor, and a shortest distance of distances between the at least one third Hall sensor and the N second magnets is greater than or equal to a fourth preset distance.

Specifically, the third motor may alternatively be a closed-loop motor with a focusing function. To be specific, the third motor includes at least one third Hall sensor. Because the third Hall sensor may interfere with the second magnets, the shortest distance of the distances between the at least one third Hall sensor and the N second magnets may be set to be greater than or equal to the fourth preset distance.

Optionally, the third Hall sensor may be disposed at a location at which a shortest distance of distances between the third Hall sensor and the M first magnets is greater than or equal to a fifth preset distance, to reduce interference between the third Hall sensor and the first magnets.

For example, the third Hall sensor may be disposed on an inner wall of a side that is of the frame of the third motor and that is farthest away from the second magnets. As shown in FIG. 11, the third Hall sensor is disposed on an inner wall of a rightmost side of the frame of the third motor, and the first magnets are disposed at locations shown in FIG. 11 as much as possible, to reduce interference between the third Hall sensor and the first magnets.

It should be understood that the third Hall sensor and a third magnet may alternatively be disposed on a same side of a frame of the motor. This is not limited in this application.

Optionally, the first motor includes at least one first Hall sensor, and a shortest distance of distances between the at least one first Hall sensor and the K third magnets is greater than or equal to a sixth preset distance.

Specifically, the at least one first Hall sensor in the first motor may be disposed at a location at which the shortest distance of the distances between the at least one first Hall sensor and the K third magnets is greater than or equal to the sixth preset distance, to reduce interference between the first Hall sensor and the third magnets.

Optionally, a cross section that is of the second motor and that is parallel to a lens surface is rectangular, and the N second magnets are disposed on a frame parallel to the second motor, or the N second magnets are disposed in four corners of the second motor.

Specifically, the cross section that is of the second motor and that is parallel to the lens surface is rectangular, and the N second magnets are each disposed on each side of a frame parallel to the second motor, for example, as shown in FIG. 7 to FIG. 10. Alternatively, the N second magnets may be disposed in four corners.

Optionally, a cross section of the first motor may also be rectangular. In this case, the M first magnets are disposed on a frame parallel to the first motor, and the M first magnets are disposed in at least two of four corners of the first motor.

Optionally, a cross section of the third motor may also be rectangular. In this case, the K third magnets are disposed on a frame parallel to the third motor, and the K third magnets are disposed in at least two of four corners of the third motor.

It should be noted that the cross section that is of the first motor, the second motor, or the third motor and that is parallel to the lens surface may also be in another regular or irregular shape. This is not limited in this application.

In addition, sizes of the first motor, the second motor, and the third motor may be the same or may be different. This is not limited in this application either.

Optionally, when a value of K is 2, the two third magnets are disposed on two sides of the third motor that are parallel to a central axis of the triple camera device, and the central axis may be a straight line in which a center of the first camera, a center of the second camera, and a center of the third camera are located.

Specifically, center axes of the first camera, the second camera, and the third camera in the triple camera device may be in a same straight line. As shown in FIG. 11, the third magnets may be disposed at locations parallel to the center axes. In this way, interference between the third magnets and the magnets in the second motor is reduced by setting a location structure.

It should be understood that a third magnet may be disposed on a left side or a right side of a frame of the third motor. This is not limited in this application.

Optionally, the third magnet is disposed in the middle of a side of the frame of the third motor. As shown in FIG. 11, the third magnet 731 is located in the middle of an upper side of the frame of the third motor, and the third magnet 732 is located in the middle of a lower side of the frame of the third motor. In this case, it is easier to dispose the magnet in the third motor, and reliability is relatively high.

Optionally, the second magnet 721 and the second magnet 723 are respectively located in the middle of an upper side and a lower side of a frame of the second motor, and the second magnet 722 and the second magnet 724 are located in the middle of a left side and a right side of the frame of the second motor.

It should be understood that the second magnet 721 and the second magnet 723 each may alternatively be disposed on a left side or a right side of the frame of the second motor, and the second magnet 722 and the second magnet 724 each may alternatively be disposed on an upper side and a lower side of the frame of the second motor. This is not limited in this application.

Optionally, the first magnet 711 and the first magnet 712 are located in the middle of an upper side and a lower side of a frame of the first motor.

It should be understood that the first magnet may be disposed on a left side or a right side of the frame of the third motor. This is not limited in this application.

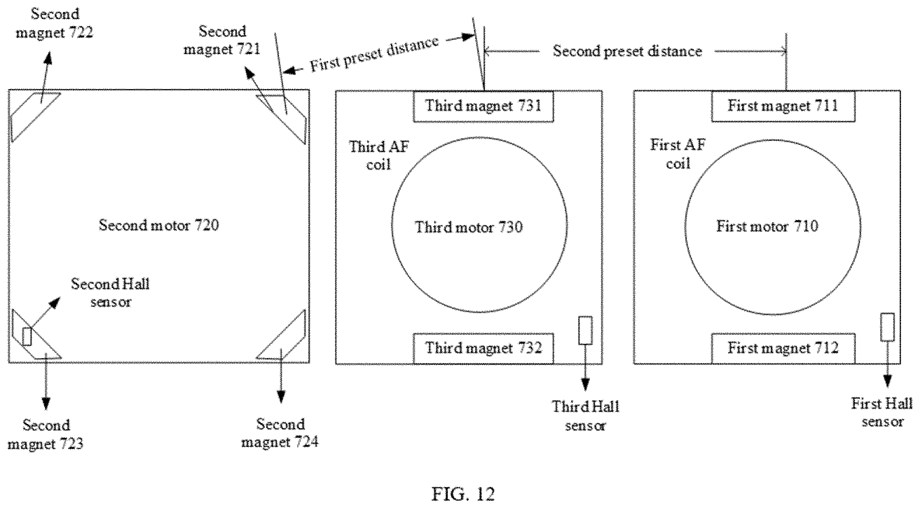

Optionally, a cross section that is of the second magnet and that is parallel to a lens surface is rectangular, or a cross section that is of the second magnet and that is parallel to a lens surface is trapezoidal. As shown in FIG. 12, the second magnet is disposed in a corner of the second motor, and the cross section parallel to the lens surface is trapezoidal.

Optionally, a cross section that is of the first magnet and that is parallel to a lens surface is rectangular, or a cross section that is of the first magnet and that is parallel to a lens surface is trapezoidal.

Optionally, a cross section that is of the third magnet and that is parallel to a lens surface is rectangular, or a cross section that is of the third magnet and that is parallel to a lens surface is trapezoidal.

Optionally, a length of the third magnet is less than or equal to a seventh preset distance.

Specifically, in the embodiments of this application, a length of the cross section that is of the third magnet and that is parallel to the lens surface may be set to be reduced as much as possible without affecting performance, to reduce magnetic interference of the third magnet to the second magnet and the first magnet.

It should be noted that the first preset distance to the seventh preset distance in the embodiments of this application each may be set to a farthest distance between modules, and the first preset distance to the seventh preset distance may be set to a same value, or may be separately set. This is not limited in this application.

Optionally, in the embodiments of this application, the length of the cross section that is of the first magnet and/or the second magnet and that is parallel to the lens surface may also be correspondingly reduced.

Optionally, the third magnet may be a bipolar magnet.

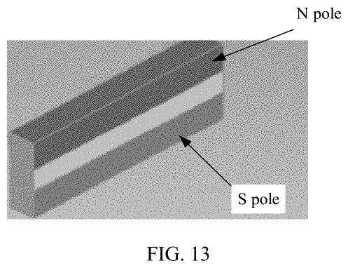

Specifically, the third motor may use the bipolar magnet (as shown in FIG. 13). Because there are two polarities on one surface of the bipolar magnet, different from divergence of a unipolar magnet, a magnetic field that faces outside and that is of the bipolar magnet is constrained, to better prevent magnetic leakage, and magnetic interference of the third motor to the first motor and the second motor can be further reduced.

It should be understood that all of a plurality of third magnets included in the third motor may be bipolar magnets, or some of the plurality of third magnets may be bipolar magnets and some of the plurality of third magnets may be unipolar magnets. This is not limited in this application.

Optionally, housing materials of the first motor, the second motor, and the third motor may be a magnetic material, so that internal components of the motors can be prevented from magnetic interference.

Optionally, housing materials of the first motor, the second motor, and the third motor may alternatively be SUS304 or SUS315.

Specifically, a housing material of a motor may be a weak magnetic material or a non-magnetic material, to further reduce magnetic interference between motors. For example, the housing material may be SUS304 or SUS315. This is not limited in this application.

It should be understood that the first motor, the second motor, and the third motor may use a same housing material, or may use different housing materials. This is not limited in this application.

Optionally, an embodiment of this application provides a terminal device, including the triple camera device according to any one of the foregoing descriptions. The terminal device includes but is not limited to a mobile phone, a mobile station, a tablet computer, a digital camera, or the like. This is not limited in this application.

Specifically, when the terminal device is a mobile phone, the terminal device includes a triple camera device, an image processing chip, a photoreceptor assembly, a display, and a battery. When the terminal device is a digital camera, the terminal device includes a triple camera device, an image processing chip, a photoreceptor assembly, an aperture, a display, a battery, a shutter, and the like. Details are not described in this embodiment of this application.

It should be understood that three cameras in the embodiments of this application may be three cameras disposed on the back of the mobile phone in parallel, or may be three cameras disposed on the front and back of the mobile phone. This is not limited in this application.

It may be clearly understood by a person skilled in the art that, for the purpose of convenient and brief description, specific operating processes of the triple camera device and the terminal device that are described above, details are not described herein again.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-14. (canceled)

15. A device, comprising:
a first camera comprising a first motor, the first motor comprising a first coil and a plurality of first magnets, and the first magnets being placed along an outer wall of the first coil and forming one or more opposite pairs;
a second camera comprising a second motor, the second motor comprising a plurality of second magnets and a plurality of second coils configured to suspend the second magnets when powered on, the second magnets being disposed in a plane and configured to support a lens of the second camera, and the second magnets forming one or more opposite pairs around an inner wall of the second motor;
a third camera comprising a third motor disposed between the first motor and the second motor, the third motor comprising a third coil and a plurality of third magnets, and the third magnets being placed along an outer wall of the third coil and forming one or more opposite pairs, and
wherein a shortest distance between the third magnets and the second magnets is greater than or equal to a first preset distance.

16. The device according to claim 15, wherein a shortest distance between the first magnets and the third magnets is greater than or equal to a second preset distance.

17. The device according to claim 15, wherein:
the second motor further comprises at least one second Hall sensor,
the second Hall sensor is disposed between one of the second magnets and the second coil corresponding to the second magnet, and
a shortest distance between the second Hall sensor and the third magnets is greater than or equal to a third preset distance.

18. The device according to claim 15, wherein the third motor further comprises at least one third Hall sensor, and a shortest distance between the at least one third Hall sensor and the second magnets is greater than or equal to a fourth preset distance.

19. The device according to claim 15, wherein the third motor further comprises at least one third Hall sensor, and a shortest distance between the at least one third Hall sensor and the first magnets is greater than or equal to a fifth preset distance.

20. The device according to claim 15, wherein the first motor further comprises at least one first Hall sensor, and a shortest distance between the at least one first Hall sensor and the third magnets is greater than or equal to a sixth preset distance.

21. The device according to claim 15, wherein:
the second motor has a rectangular frame having four sides, and
each of the second magnets is disposed in parallel with one of four sides of the rectangular frame of the second motor.

22. The device according to claim 15, wherein:
the second motor has a rectangular frame having four sides, and
each of the second magnets is disposed at a corner of the rectangular frame of the second motor.

23. The device according to claim 15, wherein:
the first motor has a rectangular frame having four sides, and
the first magnets are attached to at least two sides of the rectangular frame of the first motor.

24. The device according to claim 15, wherein:
The first motor has a rectangular frame having four sides, and
the first magnets are disposed at at least two corners of the rectangular frame of the first motor.

25. The device according to claim 15, wherein:
the third motor has a rectangular frame having four sides, and
the third magnets are disposed in parallel with at least two sides of the rectangular frame of the third motor.

26. The device according to claim 15, wherein:
the third motor has a rectangular frame having four sides, and
the third magnets are disposed at at least two corners of the rectangular frame of the third motor.

27. The device according to claim 25, wherein:
the third camera comprises two third magnets,
the two sides of the rectangular frame of the third motor that correspond to the two third magnets are parallel with a central axis of the device, and
the central axis is a straight line passing through a center of the first camera, a center of the second camera, and a center of the third camera.

28. The device according to claim 27, wherein each of the third magnets is disposed in the middle of the corresponding side of the rectangular frame of the third motor.

29. The device according to claim 15, wherein the third magnet has a cross section parallel with a lens surface of the third camera, and the cross section has a length less than or equal to a seventh preset distance.

30. The device according claim 15, wherein the second motor further comprises an additional coil, and the second magnets are disposed around an outer wall of the additional coil.

31. The device according to claim 15, wherein the first coil is an auto focus coil.

32. The device according to claim 15, wherein the second coil is an optical image stabilization coil.

33. The device according to claim 15, wherein the third coil is an auto focus coil.

34. A terminal device, comprising:
a housing, and
a camera system disposed in the housing, the camera system comprising:
a first camera comprising a first motor, the first motor comprising a first coil and a plurality of first magnets, and the first magnets being placed along an outer wall of the first coil and forming one or more opposite pairs;
a second camera comprising a second motor, the second motor comprising a plurality of second magnets and a plurality of second coils configured to suspend the second magnets when powered on, the second magnets being disposed in a plane and configured to support a lens of the second camera, and the second magnets forming one or more opposite pairs around an inner wall of the second motor;
a third camera comprising a third motor disposed between the first motor and the second motor, the third motor comprising a third coil and a plurality of third magnets, and the third magnets being placed along an outer wall of the third coil and forming one or more opposite pairs, and
wherein a shortest distance between the third magnets and the second magnets is greater than or equal to a first preset distance.
